(19) United States
(12) Patent Application Publication
(10) Pub. No.: US 2001/0008698 A1
(43) Pub. Date: Jul. 19, 2001

(54) BRASS-COLORED COATING WITH COLOR-IMPARTING NITRIDE LAYER

(76) Inventors: ELISABETH BUDKE, HURTH (DE); JORG KREMPEL-HESSE, ECKARTSBORN (DE); HANS SCHUSSLER, SCHIFFWEILER (DE); HANS MAIDHOF, GOLDBACH (DE)

Correspondence Address: SMITH GAMBRELL & RUSSELL, BEVERIDGE DEGRANDI WEILACHER & YOUNG, INTELLECTUAL PROPERTY GROUP, 1850 M STREET NW SUITE 800, WASHINGTON, DC, 20036

(21) Appl. No.: 09/263,528

(22) Filed: Mar. 5, 1999

(30) Foreign Application Priority Data
Mar. 5, 1998 (DE) 198 09 409.4

(51) Int. Cl. B32B 15/04

(52) U.S. Cl. 428/472; 428/698; 428/701; 204/192.16; 204/192.15

(57) ABSTRACT

In a process for producing a brass-colored coating for fixtures, hardware, and articles in daily use, application of an intermediate layer to the substrate or to a base coating on the substrate is made by spraying, for which purpose a magnetron source with a zirconium target is situated in the process chamber in the proximity to the substrate and a mixture of argon and nitrogen serves as process gas, and the application of the top layer by spraying is done using a zirconium target in a mixture of argon and oxygen as process gas wherein the top layer is modified by bombardment with low-energy ions in a mixture of argon as carrier gas and a reactive gas, for example oxygen or hydrogen.

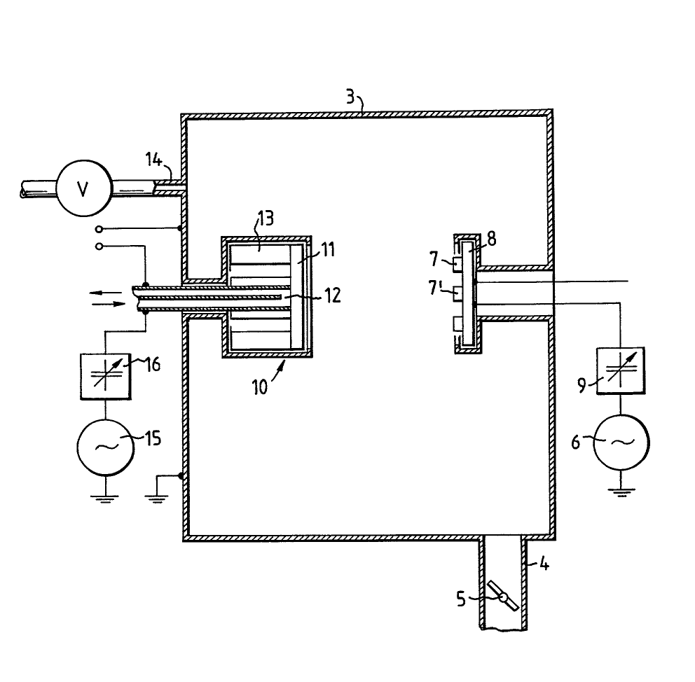

### INTRODUCTION AND BACKGROUND

The present invention pertains to a brass-colored coating with color-imparting nitride layer for bath fixtures, hardware, and articles in daily use. More particularly, the present invention pertains to articles supplied with such a coating and a process for producing a brass-colored coating with a color-imparting nitride layer.

A gold-colored coating containing zirconium nitride is known in which the coating consists of zirconium nitride and tantalum nitride with the tantalum component being from 3 wt% to 68 wt%, (DE 37 28 836 C2).

Also known are coatings for metallic utility and decorative objects (DE 25 28 255) that contain carbides and/or nitrides and/or carbonitrides, and/or borides of the elements titanium, zirconium, hafnium, niobium, tantalum, tungsten, lanthanum, cerium, and gadolinium. These substances can be used individually, in the form of mixtures, or as mixed crystals. For application of the coatings, gas phase deposition, sputtering technology, and plasma spraying are known. Coatings of only titanium nitride, titanium carbide, 10% titanium carbide and 90% titanium nitride, LaB₆, or 15% titanium carbide and 85% titanium nitride are indicated as specific examples.

In addition, articles are known (U.S. Pat. No. 5,552,233) with a multilayered coating which acts both decoratively as well as for protecting the objects, wherein the layers themselves impart the impression of brass. The layered compact consists of a first layer of semi-gloss nickel, a second layer of high-gloss nickel, a third layer of tin-nickel alloy, a fourth layer of zirconium or titanium or zirconium nitride, and a top layer of a zirconium or titanium compound.

Furthermore, a layered compact for an interference filter has also already been proposed (EP 0 622 654) wherein the first layer is a partially translucent dielectric material, a second layer is of chromium nitride, then a third reflective metal layer of silver, gold, copper, or platinum, then a fourth layer of nickel or chromium, and finally a top layer of zirconium nitride, titanium nitride, or hafnium nitride all applied to a substrate of light-permeable material.

Finally, a process is known for producing gold-colored coatings on substrates by vaporization process deposition of metals (DE 30 27 404) in which the metals are titanium, zirconium, or hafnium and are applied by electric gas discharge in a nitrogen-containing residual gas atmosphere with concurrent activation of the residual gas. In that process the gas discharge is a low-voltage arc discharge between a glow-discharge cathode and an anode and the residual gas contains a carbon-containing gaseous compound. The substrates to be coated are given a pre-charge that is negative compared to the primary voltage potential.

Accordingly, it is an object of the present invention to create a coating system in which the color of the coating can be adjusted in such a manner that it appears brass-colored; remains color-stable, scratch-resistant, wear-resistant, hard, and corrosion-resistant, even with intensive use; and can be continuously produced in simple equipment.

### SUMMARY OF THE INVENTION

The above and other objects of the present invention can be attained by forming the nitride layer which is zirconium nitride and applying the layer directly to the substrate or to a base coating on the substrate, for example, a zirconium layer as an intermediate layer, wherein, for the purpose of corrosion protection, a transparent oxidic hard material layer, preferably a zirconium oxide layer, is deposited as top layer which is modified by bombardment with low-energy ions in a mixture of argon as carrier gas and a reactive gas, for example oxygen or hydrogen, preferably oxygen.

The application of the intermediate layer is preferably by plasma spraying (sputtering) for which purpose a magnetron source with a zirconium target is arranged next to the substrate in the process chamber, and as a process gas, a mixture of argon and nitrogen is used. The application of the top layer is done by sputtering using a zirconium target in a mixture of argon and oxygen as process gas and the top layer is modified by bombardment with low-energy ions with argon and oxygen or argon and hydrogen.

The modification of the top layer is advantageously done in a pressure range of 1·10⁻³ to 10·10⁻¹ mbar, preferably 1·10⁻² mbar, wherein the proportion of oxygen in the process gas is approximately 10% and the etching voltage is adjusted to 300 V to 20,000 V, preferably 900 V.

### BRIEF DESCRIPTION OF THE DRAWINGS

The present invention permits the most various possibilities for embodiments; one of these is described in more detail below on the basis of the accompanying drawing which is a schematic representation of the apparatus used to carry out the present invention.

### DETAILED DESCRIPTION OF THE INVENTION

The apparatus for coating of substrates, for example bath fixtures or furniture hardware, comprises as the essential features a vacuum chamber 3 with a connector 4 or a turbopump (vacuum pump), a suction regulator 5 built into the connector 4, an electrically insulated substrate holder 8 for the substrates 7, 7,′, etc., an HF generator 6 with an adjustment circuit 9, a magnetron source 10 with target 11 situated opposite the substrate holder 8, a cooling device 12 and magnetic yoke 13, a connector 14 for the inflow of process gas into the vacuum chamber 3, and a generator 15 with an adjustment circuit 16 for the power supply for the magnetron source 10.

For producing a Zr/ZrN/ZrO₂coating system, the process steps and process parameters shown in the following table were used:

| | Thick- | | | | | Etch | |
|---|---|---|---|---|---|---|---|
| Process | ness | | Gases | Pressure | Power | Voltage | Bias |
| Steps | [nm] | Time | [sccm] | [mbar] | [W] | [V] | [V] |
| Free | — | 2′ | Ar, 63 | 8 | 444 | — | — |
| Sputter- | | | | | | | |
| ing | | | | | | | |
| Ar- | — | 2′ | Ar, 72, 8 | 12 | — | 800 | — |
| etching | | | | | | | |
| Free | — | 1′ | Ar, 63 | 8 | 444 | — | — |
| Sputter- | | | | | | | |
| ing | | | | | | | |
| Zr | 70 | 10″ | Ar, 63 | 8, 3 | 444 | — | — |
| Layer | | | | | | | |
| N₂ | — | | Ar, 44, 8 | 5, 1 | 444 | — | — |
| Condi- | | | N₂, 4, 8 | | | | |
| tioning | | | | | | | |
| ZrN | 330 | 2′ | Ar, 44, 8 | 5, 3 | 444 | — | 160 |
| Layer | | | N₂, 4, 8 | | | | |
| O₂ | — | 30″ | Ar, 63 | 9, 5 | 444 | — | — |
| Condi- | | | O₂, 8, 9 | | | | |
| tioning | | | | | | | |
| ZrO₂ | 9 | 10″ | Ar, 63 | 9, 7 | 444 | — | 160 |
| Layer | | | O₂, 8, 9 | | | | |
| O₂ | — | 2′ | Ar, 68 | 12 | — | 900 | — |
| Etching | | | O₂, 6, 1 | | | | |

By varying the oxide layer thickness and the concentration of the nitrogen part in the process gas, the color of the decorative coating system can be changed so that color adjustment within a certain range is possible.

The optical properties of a coating system produced with the process parameters shown in the table are:

L*>85; a*<−2.5; b*=25-29

(Hot water test: T=80° C.; t=24 h; deionized water (L<0.5 S/cm, not degassed); samples stored in isolation)

Layer thickness: 0.3-0.6 mm

The measured color fastness and color values of the system are:

DE_{ab}<1.0; a*=−2.5; b*=29.0; L*>85

As the above-indicated table shows, the layered compact was subsequently surface-modified (<20 nm) by bombardment with low-energy ions, wherein a mixture of noble gas ions in combination with reactive ions was used. In this manner, a substantial improvement of the long-term stability of these functional layers/system, especially improvement in the corrosion resistance of the treated coatings, could be attained. The described process is characterized especially by its simplicity since it can be done by the plasma etching process that is already present in most coating plants for substrate cleaning.

Thus, in a detailed aspect of the invention, there is formed in a surface of a household article such as a handle or faucet fixture a composite coating formed of an intermediate layer of zirconium nitride, ZrN, in contact with the surface of the article. Then a top coating or outer coating is formed on the intermediate layer and which is zirconium oxide, ZrO₂.

In other embodiment, the article may first have deposited thereon a base coating, such as zirconium, followed by the intermediate layer of ZrN and the top layer of ZrO₂. The use of a base coating improves adhesion, particularly in coatings where the intermediate layer is thicker than 100 nm.

Further variations and modifications of the foregoing will be apparent to those skilled in the art and are intended to be encompassed by the claims appended hereto.

German priority application 198 09 409.4 is relied on and incorporated herein by reference.

We claim:

1. A brass-colored article having a color-imparting nitride layer deposited in at least a portion of the surface of such article, wherein the nitride layer is a zirconium nitride layer and is applied directly to a substrate or to a base coating on a substrate, as an intermediate layer, a transparent oxidic hard material layer is deposited onto the intermediate layer as a top layer, wherein said top layer is then modified by bombardment with low-energy ions in a mixture of argon as carrier gas and a reactive gas.

2. The brass-colored article according to claim 1, wherein an intermediate layer of zirconium nitride is formed on a zirconium base layer.

3. The brass-colored article according to claim 1, wherein the transparent oxidized hard layer is a zirconium oxide layer.

4. The brass-colored article according to claim 1, wherein the reactive gas is oxygen or hydrogen.

5. A process for producing a brass-colored layer on the substrate, comprising depositing a nitride layer on said substrate by applying an intermediate layer onto the substrate or onto a base coating on the substrate by spraying using a magnetron source with a zirconium target situated in process chamber in proximity to the substrate in the presence of a mixture of argon and nitrogen serves as process gas, applying a top layer to the substrate by spraying using a zirconium target in a mixture of argon and oxygen as process gas and modifying the top layer by bombardment with low-energy ions in a mixture of argon as carrier gas and a reactive gas.

6. The process according to claim 5, wherein the reactive gas is oxygen or hydrogen.

7. A process according to claim 5, wherein the top layer is modified in a pressure range of 1·10^{31 3} to 1·10⁻¹ mbar, wherein the proportion of oxygen in the process gas is approximately 10% and the etching voltage is 300 V to 20,000 V.

8. The process according to claim 7, wherein the pressure is 1·10⁻² mbar.

9. The process according to claim 7, wherein the voltage is 900 V.

10. An article produced by the process of claim 5.
